(19) United States
(12) Patent Application Publication
(10) Pub. No.: US 2005/0144609 A1
(43) Pub. Date: Jun. 30, 2005

(54) Methods and apparatus to provide a robust code update

(75) Inventors: Michael A. Rothman, Olympia, WA (US); Vincent J. Zimmer, Federal Way, WA (US)

Correspondence Address: HANLEY, FLIGHT & ZIMMERMAN, LLC, 20 N. WACKER DRIVE, SUITE 4220, CHICAGO, IL, 60606, US

(73) Assignee: Intel Corporation

(21) Appl. No.: 10/734,355

(22) Filed: Dec. 12, 2003

(51) Int. Cl. G06F 9/44

(52) U.S. Cl. 717/168

(57) ABSTRACT

Methods and apparatus to provide robust code update functionality are disclosed. One example method includes receiving a pre-boot code update, storing the pre-boot code update to a first non-volatile memory if the pre-boot code update fits within an allocated space in the first non-volatile memory, and setting an indication that a pre-boot code update is to be implemented. The example method further includes reading the pre-boot code update, implementing the pre-boot code update, and clearing the indication that the pre-boot code update is to be implemented.

### TECHNICAL FIELD

The present disclosure pertains to computing systems and, more particularly, to methods and apparatus to provide a robust code update.

### BACKGROUND

Computing systems such as personal computers, which are widely used, include various components (e.g., processors, network adapters, and various other peripherals) including base level code that controls the behavior of the components. This base level code, which is commonly stored in non-volatile memory locations of the peripherals (e.g., in flash memory), is often referred to a firmware. The functionality provided by the firmware can range from controlling the base level operation of the components to storing user-defined settings or preferences of the components.

From time to time, component vendors such as processor vendors provide firmware or code updates that are obtained and installed by consumers. Firmware updates range from simple upgrades for peripheral components to critical processor firmware updates that drastically affect the operation of the computing system. For example, updating processor firmware is a critical procedure, the failure of which could result in inoperability of a computing system relying on the operation of the processor and its associated firmware.

Today, firmware updates are most commonly made available via access to vendor Internet web pages on which the updates are made publicly available. For example, a consumer can navigate his or her browser to a vendor Internet page and execute the firmware update during operating system (OS) runtime. Accordingly, updates are commonly initiated during OS runtime and include no media (e.g., a diskette) on which the updated firmware is stored prior to installation. Most conventional computing systems stage downloaded firmware updates through memory buffers, which are volatile (i.e., the memories lose their contents if the memories lose power). For example, an OS-initiated firmware update may be conveyed by a memory buffer either to a system management mode (SMM) (legacy) or through a capsule update (extensible firmware interface (EFI)).

The conventional firmware update process, which uses volatile memory, may cause a serious point of failure if the firmware update does not proceed smoothly. For example, if a power loss were to occur during a firmware upgrade, the system firmware will be compromised in that it may be partially overwritten with the updated firmware, resulting in a set of invalid firmware instructions. In addition, because the update was stored in a volatile memory, the update would be lost during the power interruption. In such a situation, only the protected boot block of the firmware will be valid in the computing system because the boot block of the system may never be overwritten. The only way to recover the compromised firmware is for the system user to have a physical media containing a firmware image that may be used to recover the system to a working state. However, because the firmware update was downloaded from the Internet into a volatile memory location, most users do not have the firmware update stored on bootable physical media such as a diskette. When the system is unbootable, there are no means by which a user can fix the system without the use of an emergency disk, which most users do not have on hand and which users cannot create once the system is unbootable. Accordingly, users in such a situation commonly must make a service call to a service technician or ship the computing system to the vendor from whom they purchased the system.

### BRIEF DESCRIPTION OF THE DRAWINGS

FIG. 1 is a block diagram of an example robust code update system.

FIGS. 2A and 2B form a flow diagram of an example robust firmware update process.

FIG. 3 is a block diagram of an example processor system in which the robust firmware update process of FIG. 2 may be implemented.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware, software, and/or firmware components could be embodied exclusively in dedicated hardware, exclusively in software, exclusively in firmware, or in some combination of hardware, firmware, and/or software. Further, while the following discloses example systems in which firmware residing in computing system flash is updated, those having ordinary skill in the art will readily recognize that the disclosed methods and apparatus may be used to perform any code upgrade, be it firmware, software, or otherwise. Accordingly, while the following describes example systems, persons of ordinary skill in the art will readily appreciate that the examples are not the only way to implement such systems.

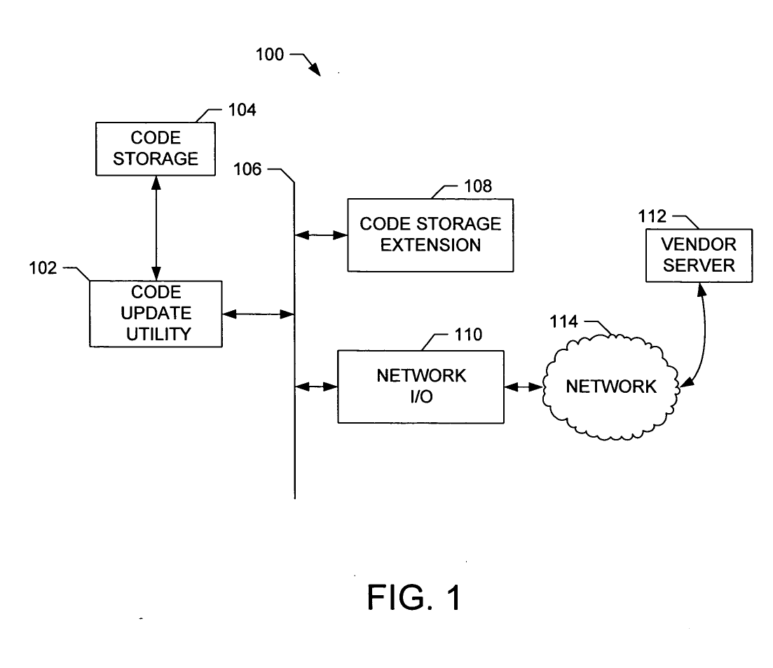

Turning now to FIG. 1, an example of a robust code update system 100 includes a code update utility 102 that may be coupled to a code storage block 104 and may be further coupled to an interface 106. As further shown in the example of FIG. 1, the system 100 further includes a code storage extension 108 and a network input/output (I/O) block 110 that may also be coupled to the interface 106. The system 100 may be coupled to a vendor server 112 via a network 114 and the network I/O block 110.

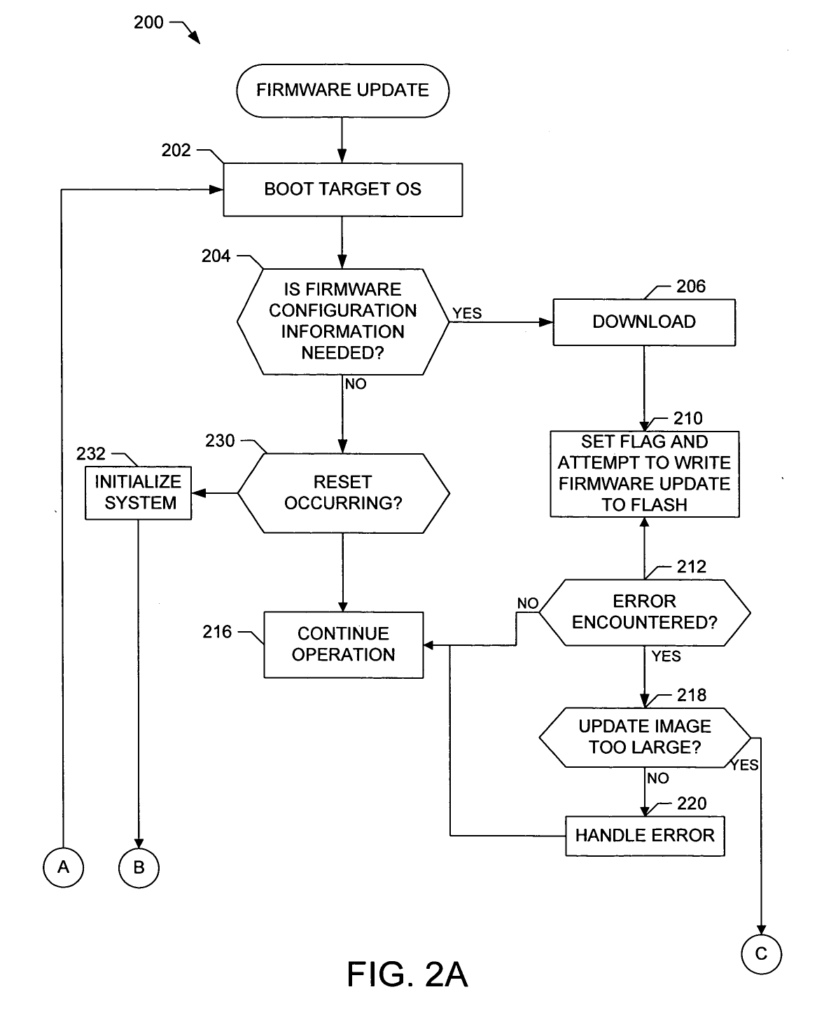

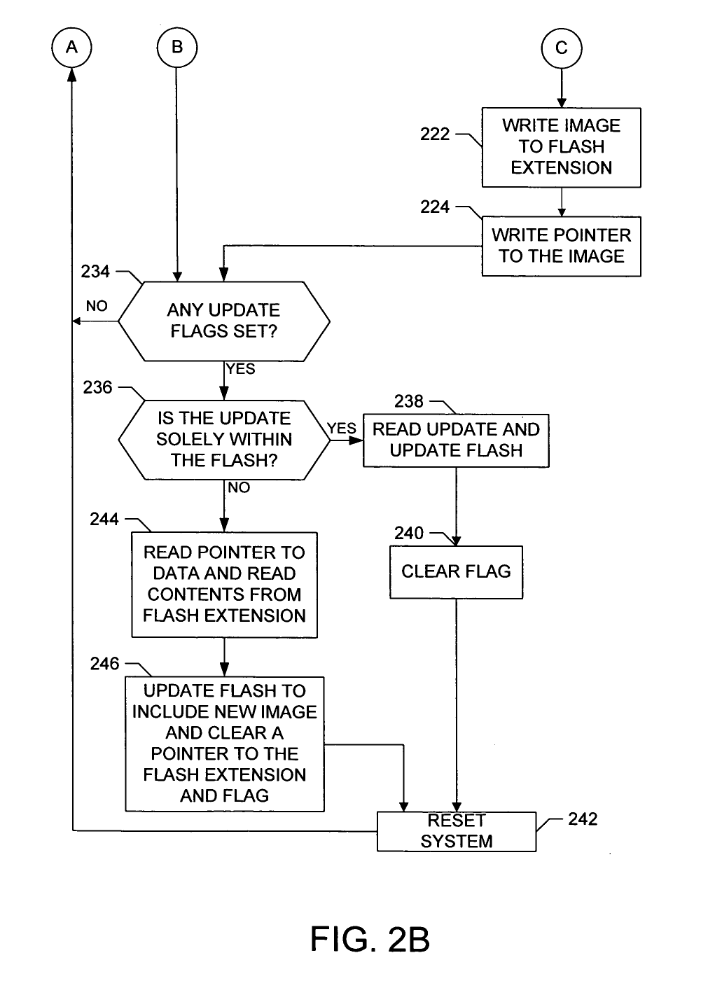

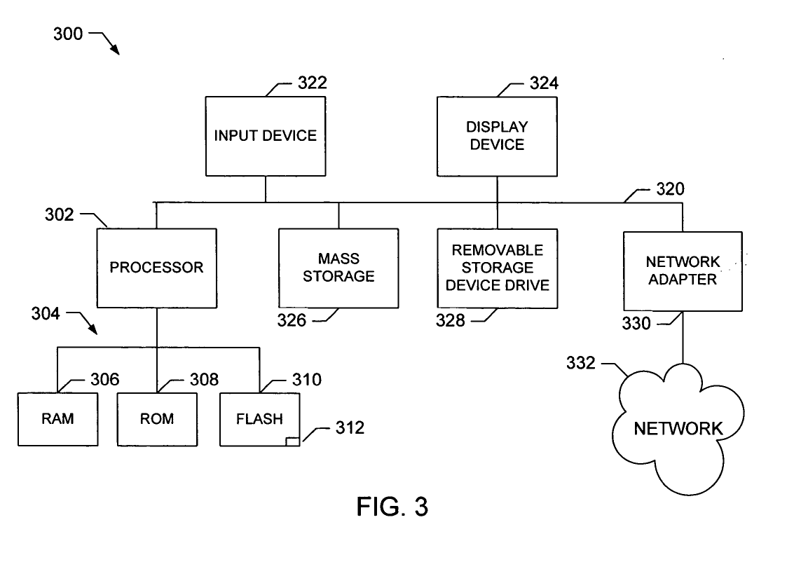

The code update utility 102 may be implemented, for example, by a processor (e.g., the processor described in conjunction with FIG. 3 below) executing code such as firmware code in a pre-boot environment (i.e., before the booting of an operating system) and/or in a post-boot environment (i.e., after the booting of an operating system). The code executed by the processor to implement the code update utility may be stored in a memory (e.g., one of the memories described below in conjunction with FIG. 3) coupled to the processor. The functionality imparted to the processor by the code is described below in conjunction with FIG. 2.

The code storage block 104 may be implemented by, for example, flash memory (e.g., the flash memory described below in conjunction with FIG. 3) and the code stored therein may be implemented using firmware instructions that may be executed by a processor in a pre-boot environment. The code storage block 104 may be implemented on a memory that is part of or is separate from the processor used to implement the code update utility 102.

The interface 106 may be implemented using a conventional processor bus that may be coupled to various other system components to facilitate communication therewith. Alternatively, the interface 106 may be implemented using any parallel or serial bus architecture.

The code storage extension 108 may be implemented using, for example, a mass storage device (e.g., the mass storage device described in conjunction with FIG. 3 below) such as a hard disk drive, or any other magnetic, electronic, or optical media on which code, information, or instructions may be stored. It is advantageous that the code storage extension 108 be a non-volatile memory so that any information written therein will exist regardless of whether the system 100 loses power. Additionally, the portion of the mass storage device used to implement the code storage extension 108 may be defined using host-protected architecture techniques to prevent inadvertent or malicious changes to information in the code storage extension 108.

The network I/O block 110 may be implemented using any suitable network interface device such as a modem, an Ethernet card, a wireless interface card, or any other suitable network interface device. Further detail pertinent to the network I/O block 110 is provided below in conjunction with FIG. 3 and the various interface devices described in connection therewith.

The vendor server 112, which is separate from the system 100, may be implemented using computer hardware such as, for example, a personal computer, a laptop computer, or a server. In particular, the vendor server 112 may store various code updates that are to be downloaded by the code update utility 102 and implemented in the code storage block 104 and/or the code storage extension 108.

As will be readily appreciated by those having ordinary skill in the art, the network 114 used to link the system 100 to the vendor server 112 may be implemented by any local area network (LAN), wide area network (WAN), or any other suitable network configuration may be provided. In particular, the network 114 may be implemented using the Internet. Additional details pertinent to the various networks that may be used in conjunction with the system 100 are provided below in connection with FIG. 3.

In general, and as described in detail below in conjunction with FIG. 2, the code update utility 102 accesses the vendor server 112 via the interface 106, the network I/O block 110, and the network 114 to obtain code updates (e.g., pre-boot code updates, updated flash and/or firmware images) that may, for example, affect the operation of the processor on which the code update utility 102 operates. The code updates from the vendor server 112 may be written to the code storage block 104 (if space permits) and staged for installation in a manner in which the processor tracks whether the code update has been thoroughly completed. For example, as described in detail below in conjunction with the process of FIG. 2, a flag may be set when a code update is obtained and cleared after the obtained code update is successfully installed. In the alternative, if the code update is too large to fit within the code storage 104, the code update may be stored to the code storage extension 108 and a pointer to the code update located in the code storage extension 108 may be written to the code storage block 104.

A flow diagram representing a robust firmware update process 200 is now described in conjunction with FIGS. 2A and 2B (collectively FIG. 2). In general, the process 200 may be implemented using one or more software programs or sets of instructions or codes that are stored in one or more memories (e.g., the memories 306, 308, and/or 310 of FIG. 3) and executed by one or more processors (e.g., the processor 302). However, some of the blocks of the process 200 may be performed manually and/or by some other device. Additionally, although the process 200 is described with reference to the flowchart of FIG. 2, persons of ordinary skill in the art will readily appreciate that many other methods of performing the process 200 may be used. For example, the order of many of the blocks may be altered, the operation of one or more blocks may be changed, blocks may be combined, and/or blocks may be eliminated. In particular, the process 200 is one example of a process that may be carried out by the code update utility 102 of FIG. 1 as implemented by a processor. Accordingly, while the process 200 is described in terms of firmware updates that may be implemented, those having ordinary skill in the art will readily recognize that updates to other types of code may be implemented in a like manner and, therefore, the operation of the code update utility 102, while illustrated in conjunction with firmware, should not be limited to the updating of firmware.

The process 200 begins when a target OS is booted (block 202). The booting of the target OS may be controlled by an OS loader that may be called by a portion of firmware stored in flash memory and referred to as the boot block of the system. After the OS is booted, the process 200 determines if firmware configuration information is needed (block 204). As used herein, the term configuration information may include any type of code implemented in software or firmware. In one particular example, configuration information may be pre-boot code updates, firmware updates, flash updates, flash images, or the like that are to be implemented. The process 200 may determine that firmware configuration information is needed by a user initiating an OS-present firmware update using a capsule update or through a system management mode. Alternatively, the need for firmware configuration information may be carried out by firmware update utility that monitors one or more locations for the availability of updated firmware images. Such locations may be local or may reside remotely on servers linked via the Internet to the hardware running the process 200.

If firmware configuration information is needed (block 204), the configuration information is downloaded (block 206). In one example, the configuration information may be downloaded via a network connection such as an Internet connection. In such an example, the configuration information may be downloaded from a server that provides firmware or software updates. For example, processor or other hardware vendors may provide code updates on websites or file transport protocol (FTP) sites that are customer-accessible.

As described below, the firmware configuration information that is downloaded (block 206) may be advantageously stored in a non-volatile memory before the updates are applied. For example, the configuration information the configuration information may be stored in variable space allocated in the firmware storage (e.g., in the code storage 104 of FIG. 1 or in the flash memory 310 of FIG. 3). In such an arrangement, 64 kilobytes (KB) of memory may be allocated in the flash memory for storing updates to be made. Additionally or alternatively, the updates may be downloaded to any non-volatile memory such as the code storage extension 108 (FIG. 1). As will be readily appreciated, the configuration information may be stored using host-protected architecture techniques.

As the firmware configuration information is downloaded (block 206), a flag is set and the process 200 attempts to write the firmware update to flash memory (block 210) for storage until the configuration information may be installed or applied. In one example, the configuration information may be stored in variable space of the flash memory, which may have a size on the order of 64K. Alternatively, the configuration information may be written to any other suitable non-volatile memory. The flag may be a bit or byte stored in a memory or register that represents whether a firmware update has been received, but not yet successfully installed. When the flag is set, there is a firmware update awaiting installation. As explained in detail below, when installation is complete, the flag will be cleared to indicate that there are no more firmware updates awaiting installation.

When the processor attempts to write information (i.e., the configuration information) to flash memory (block 210), errors may result for a number of different reasons. For example, the flash memory may be inaccessible or write protected. Additionally, an error may result when a processor attempts to write too much information to the flash memory (i.e., when the configuration information is larger than the allocated memory space in the flash memory). If an error is not encountered in writing the configuration information to flash memory (block 212), operation of the system returns to normal in which the OS operates normally (block 216).

Alternatively, if an error is encountered when the processor attempts to write the configuration information to the flash memory (block 212), the process 200 determines if the error occurred because the information to be written to the flash memory was too large for the flash memory (i.e., was the updated flash image too large for the variable space of the flash memory, which is on the order of 64K in size) (block 218). If the error was not because the update image was too large (block 218), the process handles the error using conventional techniques (block 220).

Alternatively, if the error was due to the configuration information being too large for the flash memory (block 218), the update image that was originally to be written to the flash memory is written to the code storage extension (block 222). In one example, the code storage extension 108 of FIG. 1 may be more specifically referred to as a flash extension. As noted previously, the flash extension or the code storage extension may be implemented using memory, a hard disk drive, or any other suitable non-volatile memory device. After the image is written to the code storage extension (block 222), a pointer to the image in the code storage extension is written into the flash (block 224). The pointer may be, for example, 30-40 bytes in size, which fits well within the 64K variable space in the flash memory. The pointer will instruct the processor where to find the additional firmware code.

Returning the description associated with the block 204, if firmware configuration information is not needed, the process 200 determines whether a reset is occurring (block 230). If a reset is not occurring, normal operation is continued (block 216). Alternatively, if a reset is occurring (block 230), the hardware and software of the system are initialized (block 232) and the processor begins executing boot code out of the flash memory. This operation results in the re-boot of the system and, therefore, the OS is killed.

After the system is initialized (block 232), or after the pointer to the image in the firmware extension is written to the firmware (block 224), the process 200 determines if there are any update flags set (i.e., if there are any updates to be implemented in the system) (block 234). If no update flags are set, the target OS is booted (block 202). Alternatively, if there are updates to be implemented as represented by the flags (block 234), the process determines if the updates are solely within the flash (block 236), meaning that the configuration information (e.g., flash updates, flash images, etc.) is located in the variable space of the flash memory. If the updates are solely within the flash memory (block 236), the updates are read and implemented into the flash (block 238). After the updates are made successfully, the flag is cleared (block 240) and the system is reset (block 242), which eventually results in the booting of the target OS 202.

Alternatively, if the update is not stored solely within the flash (block 236), the pointer to the code storage extension is read from the flash (e.g., from the variable space of the flash) and the content from the code storage extension is read (block 244). After the content from the code storage extension is read, the contents of the flash are updated to include the new image and the pointer to the code storage extension and the flag are cleared (block 246). Subsequently, the system is reset (block 242) and the target OS is booted (block 202).

Referring now to FIG. 3, an example processor system 300 on which the process 200 may be implemented is shown. As shown in FIG. 3, the system 300 includes a processor 302 having associated memories 304, such as a random access memory (RAM) 306, a read only memory (ROM) 308, and a flash memory 310, any or all of which may be used to store code, data, or instructions. The flash memory 310 of the illustrated example includes a boot block 312. The processor 302 is coupled to an interface, such as a bus 320 to which other components may be interfaced. In the illustrated example, the components interfaced to the bus 320 include an input device 322, a display device 324, a mass storage device 326, and a removable storage device drive 328. The removable storage device drive 328 may include associated removable storage media (not shown), such as magnetic or optical media. The processor system 300 may also include a network adapter 330.

The example processor system 300 may be implemented by, for example, a server, a remote device, a conventional desktop personal computer, a notebook computer, a workstation, or any other computing device. The processor 302 may be any type of processing unit, such as a microprocessor from the Intel® Pentium® family of microprocessors, the Intel® Itanium® family of microprocessors, and/or the Intel XScale® family of processors.

The memories 304 that are coupled to the processor 302 may be any suitable memory devices and may be sized to fit the storage and operational demands of the system 300. In particular, the flash memory 310 may be, for example, a 1 MB device including non-volatile memory that is accessed and erased on a block-by-block basis and that stores instructions that cause the processor 302 to carry out prescribed actions in a pre-boot environment.

The input device 322 may be implemented using a keyboard, a mouse, a touch screen, a track pad or any other device that enables a user to provide information to the processor 302.

The display device 324 may be, for example, a liquid crystal display (LCD) monitor, a cathode ray tube (CRT) monitor or any other suitable device that acts as an interface between the processor 302 and a user. The display device 324 includes any additional hardware required to interface a display screen to the processor 302.

The mass storage device 326 may be, for example, a conventional hard drive or any other magnetic or optical media that is readable by the processor 302. The mass storage device 326 may be used to implement the flash or code storage extension described above. For example, the mass storage device 326 may be implemented using a hard disk drive that may include a hidden partition or a section that is otherwise prevented from being overwritten so that this section may be used to implement the code storage extension into which flash updates may be written before they are implemented or into which flash updates exceeding the size of the flash memory may be stored and accessed via a pointer located in the flash memory.

The removable storage device drive 328 may be, for example, an optical drive, such as a compact disk-recordable (CD-R) drive, a compact disk-rewritable (CD-RW) drive, a digital versatile disk (DVD) drive, or any other optical drive. The removable storage device drive 328 may alternatively be, for example, a magnetic media drive. If the removable storage device drive 328 is an optical drive, the removable storage media used by the drive 328 may be a CD-R disk, a CD-RW disk, a DVD disk, or any other suitable optical disk. On the other hand, if the removable storage device drive 48 is a magnetic media device, the removable storage media used by the drive 328 may be, for example, a diskette or any other suitable magnetic storage media.

The network adapter 330 may be any suitable network interface such as, for example, an Ethernet card, a wireless network card, a modem, or any other network interface suitable to connect the processor system 300 to a network 332. The network 332 to which the processor system 300 is connected may be, for example, a local area network (LAN), a wide area network (WAN), the Internet, or any other network. For example, the network could be a home network, a intranet located in a place of business, a closed network linking various locations of a business, or the Internet.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

1. A method of updating code comprising:
receiving a pre-boot code update;
storing the pre-boot code update to a first non-volatile memory if the pre-boot code update fits within an allocated space in the first non-volatile memory;
setting an indication that a pre-boot code update is to be implemented;
reading the pre-boot code update;
implementing the pre-boot code update; and
clearing the indication that the pre-boot code update is to be implemented.

2. A method as defined by claim 1, comprising writing the pre-boot code update to a second non-volatile memory if the pre-boot code update does not fit within the allocated space in the first non-volatile memory and writing in the first non-volatile memory a pointer to the pre-boot code update stored in the second non-volatile memory.

3. A method as defined by claim 2, wherein the second non-volatile memory comprises a portion of a mass storage device.

4. A method as defined by claim 1, wherein the pre-boot code update comprises a firmware update.

5. A method as defined by claim 1, wherein the indication that the pre-boot code update is to be implemented comprises setting a flag.

6. A method as defined by claim 1, wherein the first non-volatile memory comprises a flash memory storing firmware instructions.

7. A method as defined by claim 1, wherein the pre-boot code update is stored in a host-protected architecture.

8. An article of manufacture comprising a machine-accessible medium having a plurality of machine accessible instructions that, when executed, cause a machine to:
receive a pre-boot code update;
store the pre-boot code update to a first non-volatile memory if the pre-boot code update fits within an allocated space in the first non-volatile memory;
set an indication that a pre-boot code update is to be implemented;
read the pre-boot code update;
implement the pre-boot code update; and
clear the indication that the pre-boot code update is to be implemented.

9. A machine-accessible medium as defined by claim 8, wherein the machine accessible instructions, when executed, cause the machine to write the pre-boot code update to a second non-volatile memory if the code update does not fit within the allocated space in the first non-volatile memory and write in the first non-volatile memory a pointer to the pre-boot code update stored in the second non-volatile memory.

10. A machine-accessible medium as defined by claim 9, wherein the second non-volatile memory comprises a portion of a mass storage device.

11. A machine-accessible medium as defined by claim 8, wherein the pre-boot code update comprises a firmware update.

12. A machine-accessible medium as defined by claim 8, wherein the indication that the pre-boot code update is to be implemented comprises setting a flag.

13. A machine-accessible medium as defined by claim 8, wherein the memory comprises a flash memory storing firmware instructions.

14. A machine-accessible medium as defined by claim 8, wherein the pre-boot code update is stored in a host-protected architecture.

15. A system comprising:
a network connection;
a flash memory;
a non-volatile memory; and
a processor coupled to the network connection, the flash memory and the non-volatile memory, the processor programmed to:
receive a pre-boot code update;
store the pre-boot code update to the flash memory if the pre-boot code update fits within an allocated space in the flash memory;
set an indication that a pre-boot code update is to be implemented;
read the pre-boot code update from the flash memory;
implementing the pre-boot code update; and
clearing the indication that the pre-boot code update is to be implemented.

16. A system as defined by claim 15, wherein the processor is programmed to write the pre-boot code update to the non-volatile memory if the pre-boot code update does not fit within the allocated space in the flash memory and to write in the flash memory a pointer to the pre-boot code update stored in the non-volatile memory.

17. A system as defined by claim 15, wherein the pre-boot code update comprises a firmware update.

18. A system as defined by claim 15, wherein the pre-boot code update is stored in a host-protected architecture.

19. A system as defined by claim 15, wherein the non-volatile memory comprises a portion of a mass storage device.

20. A system as defined by claim 15, wherein the allocated space in the flash memory comprises a variable storage space.
